(19) United States
(12) Patent Application Publication
(10) Pub. No.: US 2009/0140926 A1
(43) Pub. Date: Jun. 4, 2009

(54) System and method for localization utilizing dynamically deployable beacons

(76) Inventor: Elden Douglas Traster, Indianapolis, IN (US)

Correspondence Address: BOWMAN & ASSOCIATES, 1016 3rd Avenue, SW, Suite #106, CARMEL, IN, 46032, US

(21) Appl. No.: 11/999,199

(22) Filed: Dec. 4, 2007

(51) Int. Cl. G01S 1/00

(52) U.S. Cl. 342/463; 342/357.06

(57) ABSTRACT

A beacon-based localization system utilizes a mobile object with dynamically deployable beacons for guiding the mobile object. In one form, the localization system includes a mobile object, at least two beacons and preferably a plurality of beacons, and devices for deploying and retrieving beacons. The mobile object, as well as the beacons, includes location determination units for determining location of a beacon, and communications units for communicating with the mobile object and other beacons. The mobile object deploys beacons at various known and determined locations. Initially placed beacons can provide enough location information to establish an initial work area. After work is completed in the initial area, or to cover blocked portions of the initial area, the mobile object can retrieve one or more of the beacons and place them at a new location or strategically place additional beacons from the mobile object. After each placement of an additional beacon the location is stored for later use in the localization computations. Once the work area coverage has been expanded or improved, work can continue.

### BACKGROUND OF THE INVENTION

1. Field of the Invention

The present invention relates to beacon-based localization systems for mobile objects and, more specifically, to a beacon-based localization system for mobile objects utilizing deployable beacons.

2. Background Information

Numerous variations of beacon-based localization systems for mobile objects have been developed in the past. Many of these systems measure the time-of-flight for a sonic signal between a mobile object and a beacon. The speed of the signal can be taken as a known, or for more accuracy it can be calculated in some way at the time of the measurement. The mobile object can then determine the distance between itself and the beacon by multiplying the time-of-flight of the signal and the speed of the signal into a distance. When three or more beacons are situated within range of the mobile object, and their locations and distances are known, a determination about location of the mobile object within the plane can be made. A fourth beacon, outside of the plane of the original three, allows the mobile object to determine its location within three dimensions.

Conventional beacon-based localization systems require that the beacons be placed by a human within the work area. The beacons can be permanently installed or temporarily set up while work is performed. Permanent installations have the advantage of requiring less human input in the future, but the disadvantage of existing in an ever changing environment where new objects could block the signal path. Temporary installations require more human setup time, but are less susceptible to signal blocking objects. However, even temporary installations cannot guarantee that new objects will not block a beacon's signal during a work session. Neither type of installation can overcome signal blockage created by large objects in the middle of the work area unless additional beacons are utilized.

Additionally, beacon location information is required for the mobile object to determine its position. This information must either be provided to the mobile object, or the system must include functionality for determining this information after placement. Furthermore, permanently placed beacons requiring power must either be regularly recharged by a person or be permanently wired to a power supply system.

Moreover, in these conventional systems, the mobile object must stay within range of three beacons at all times to determine position. Based on the relatively short range of sonic signals this requirement restricts the mobile object to a small work area or requires a large number of beacons. Beacon failure results in portions of the work area becoming unavailable to the mobile object.

In view of the above conventional systems, it is an object of the present invention to provide a beacon-based localization system and/or method that overcomes the problems and/or shortcomings of the prior art.

Additionally, it is an object of the present invention to provide a beacon-based localization system and/or method having dynamically deployable beacons.

### SUMMARY OF THE INVENTION

In order to overcome the problems with the related art, the present invention has systems and methods for deploying and moving beacons of a beacon-based localization system that can be used for guiding a mobile object.

According to one aspect of the invention, a localization system includes a mobile object, at least two beacons, and devices for deploying/placing and retrieving beacons. The mobile object can initially place two beacons at known locations. These initial beacons can provide enough location information to establish an initial work area. After work is completed in the initial area, or to cover blocked portions of the initial area, the mobile object can retrieve one or more of the beacons and place them at a new location. After each placement of an additional beacon the location is stored for later use in the localization computations. Once the work area coverage has been expanded or improved work can continue.

In accordance with another aspect of the invention, the beacons themselves contain hardware similar to that in the mobile object allowing them to determine their own location and transmit that information to the other beacons and the mobile object. Also, the beacons may have propulsion systems allowing them to position themselves within the environment. The mobile object can issue directions to the beacons with no need to stop work, retrieve and relocate them.

The present localization system allows mobile objects to navigate autonomously in a changing outdoor environment without the need for human intervention and large beacon emplacements.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a diagram showing an overview of the present localization system;

FIG. 2 is a block diagram of a mobile object of the present localization system;

FIG. 3 is a side view of an embodiment of the mobile object;

FIG. 4 is an enlarged top perspective view of an embodiment of a beacon placement unit of the present mobile object;

FIG. 5 is a flow chart showing an overview of a process used to localize and guide the present mobile object;

FIG. 6 is a more detailed flow chart showing the present process of localizing and guiding the mobile object;

FIG. 7 is a diagram showing potential multipath and occlusion errors;

FIG. 8 is a flow chart showing a process used to improve location information of a placed or deployed beacon;

FIG. 9 is a diagram showing the present mobile object performing measurements necessary to improve the location information of a placed beacon; and

FIG. 10 is a self moving beacon of an alternate embodiment.

A detailed description of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF THE PREFERRED EMBODIMENT

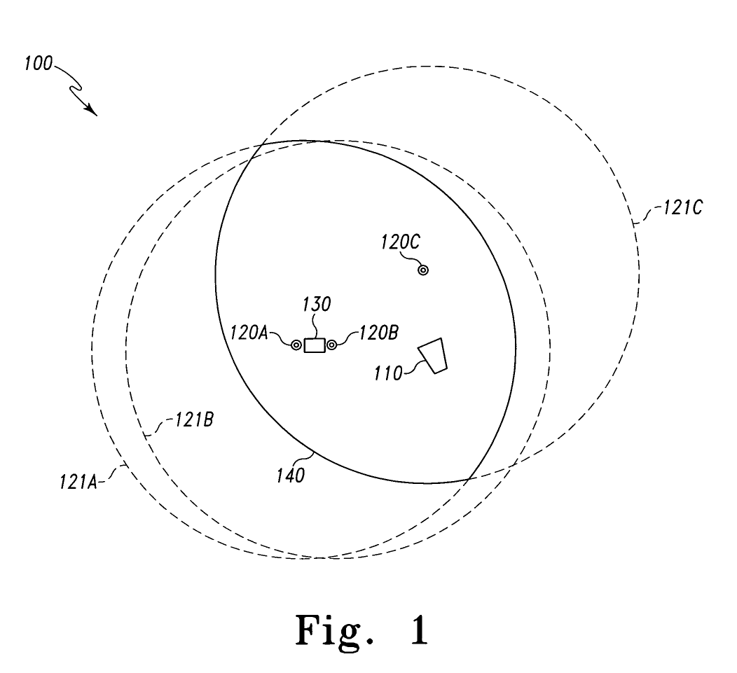

FIG. 1 is a diagram showing an overview of a localization system 100 designed to direct and guide a mobile object 110. The system 100 contains at least two dynamically positionable or deployable beacons 120A and 120B, each with a corresponding field of coverage 121A and 121B. The system 100 determines the location of the mobile object 110 and directs its course based upon information sent and received by the beacons 120A and 120B. The system 100 is also capable of determining when the mobile object 110 is likely to move out of range of the fields of coverage 121A and 121B and directing the placement or deployment of additional beacons. These beacons could be extras carried on board the mobile object 110 or previously deployed beacons recovered for further use.

In the preferred embodiment of the invention, the system 100 comprises a mobile object 110 and three dynamically positionable/deployable beacons 120A, 120B and 120C. Each beacon has a corresponding field of coverage 121A, 121B, and 121C. The fields 121A, 121B and 121C can vary in size and shape based upon the localization technology used in the beacons 120A, 120B and 120C. The beacons could utilize various forms of electronics to receive and generate any combination of light, electromagnetic, or acoustic energy. The beacons 120A, 120B and 120C could also be passive, without electronics, acting simply as reflectors. The specific technology used in the/beacons does not matter as long as it does not affect the ability to dynamically position the beacons.

In order to establish a reference point, two beacons, 120A and 120B, are placed or deployed within the system 100 by the mobile object 110. The location of the mobile object 110 can be determined from a minimum of two beacons. However, localizing from only two beacons leaves an ambiguity that requires either a third beacon 120C or external information to resolve. Dead reckoning, while typically not accurate enough to enable useful work, can provide the necessary external information to overcome the ambiguity of a two beacon system. As an alternate to dead reckoning, careful initial beacon placement can resolve the ambiguity by ensuring that it is impossible for the mobile object to be at one of the points. An example of this practice would involve placing the beacons next to a fence with one of the ambiguous points located on the other side. In yet another alternative, information regarding the angle of reception of the incoming signal at the mobile object 110 would also resolve the ambiguity.

The reference establishing beacons 120A and 120B are preferably placed next to a recognizable landmark 130, such as a bench, tree, concrete pad, etc. This placement next to a known point allows an absolute reference to be created. After the initial beacons are placed, additional beacons, such as 120C, can be placed to provide unambiguous localization information within the area 140.

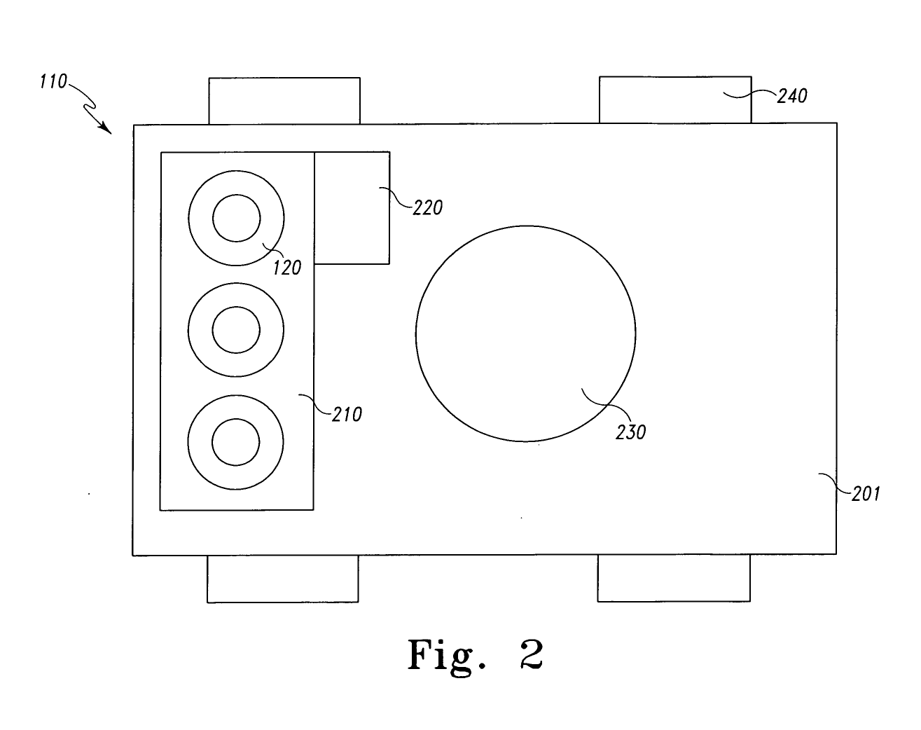

FIG. 2 is a block diagram showing a simple embodiment of the mobile object 110. Powered wheels 240 attached to the base 201 provide a mobile platform. Multiple beacons 120 can be stored in the beacon positioning unit 210. The beacon positioning unit 210 is also capable of placing the beacons onto the target surface. While stored on the mobile object the beacons 120 can be recharged by the beacon recharging unit 220, which draws power from the mobile object power system. The location determination unit 230 is also on the mobile object 110 and determines both location and navigation instructions from its communications with the beacons 120.

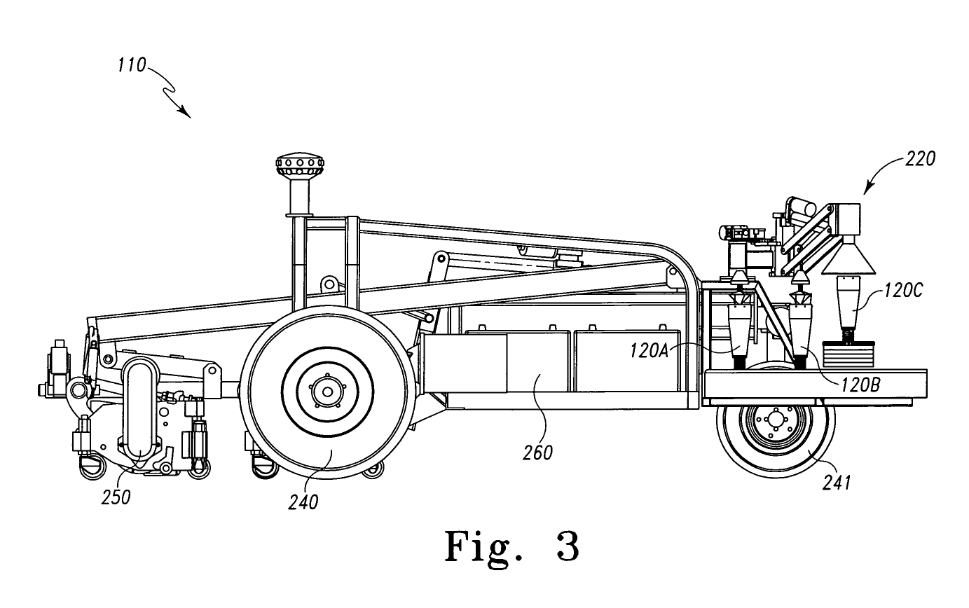

FIG. 3 is a diagram showing a preferred embodiment of a mobile object 110. Preferably, the mobile object 110 includes two independently driven front wheels 240 and a steered rear wheel 241. The beacon placement or deployment unit 220 is capable of placing or deploying and retrieving one of the beacons 120A, 120B or 120C. The mobile object includes a transmitter/receiver array 210 for sending ultrasonic signals and detecting a return infrared signal from a beacon 120A, 120B or 120C. The mobile object 110 is powered by batteries 260, but another power source, such as an internal combustion engine, is contemplated.

The system 100 can perform localization calculations using either time of flight or angular reception information. A combination of the two methods may be useful for increasing accuracy and avoiding errors. Angular information can be useful in eliminating multipath since the mobile object 110 can roughly determine the angular relationship between itself and a beacon 120, it can anticipate the arrival angle of the infrared signal from the beacon. If the angles differ it is likely due to a multipath reflection and the information should be discarded.

A mowing unit 250 is attached to the front of the mobile object 110, but any unit capable of performing useful work could be substituted. Examples of work units include, but are not limited to sweepers, vacuums, mowers, sprayers, and spreaders.

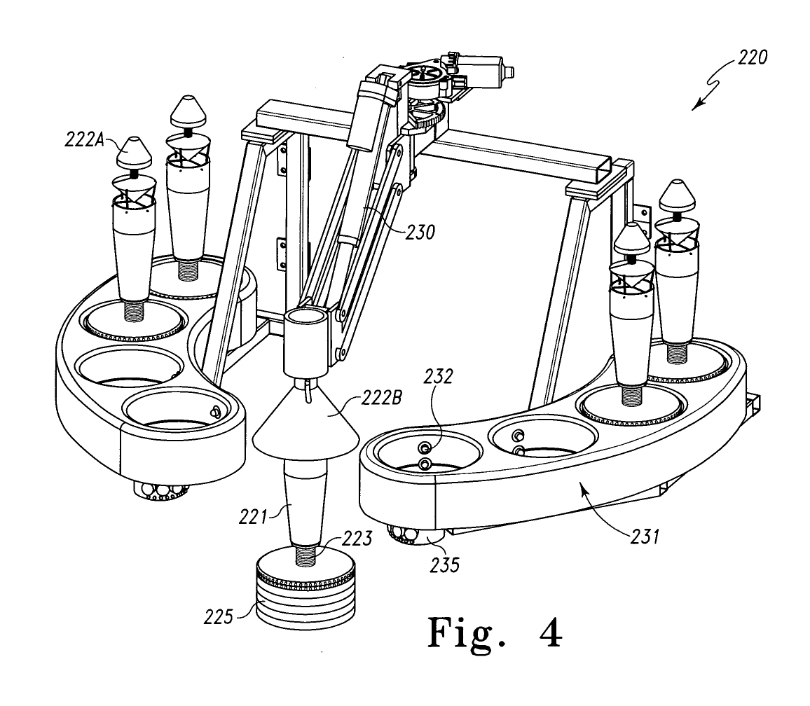

The beacon placement unit 220 is described with reference to FIG. 4. The unit is capable of storing, placing, retrieving, and charging the rechargeable beacons (beacons may be solar powered, battery powered, derive power from other sources, or a combination thereof. Transmitter/receiver units 235 are placed at the deployed level of the beacon. The units 235 transmit an ultrasonic signal (to the beacons) and receive an infrared signal (from the beacons) for determining the location of the beacon once the main array 210 can no longer communicate.

Each beacon contains a guidance cone 222A which corresponds to the guidance cone 222B on the mobile object for deployment and/or retrieval of the beacons. The cones reduce the need for precision orientation by causing the upper portion 221 of a beacon to flex at the spring connector 223 of the beacon. An electromagnet inside 222B can energize and lock onto a ferromagnetic guidance cone 222A to pick up the beacon for deployment and/or retrieval.

The placement arm 230 can raise and lower as well as swing side to side to retrieve a previously placed beacon and then drop the retrieved beacon into a housing 231. The base 225 of a beacon has electrical contacts to meet the charging contacts 232 in the housing 231 and recharge the beacon's batteries from the main batteries 260 of the mobile object 110.

In another embodiment, additional mobile objects could be added to the localization system 100. The mobile objects could be capable of performing different types of tasks within the area or each contribute work to the same task. When multiple mobile objects are in the system, the same set of dynamically positionable beacons could be used by each of the mobile objects. If each mobile object carried its own compliment of beacons then the work area could be expanded.

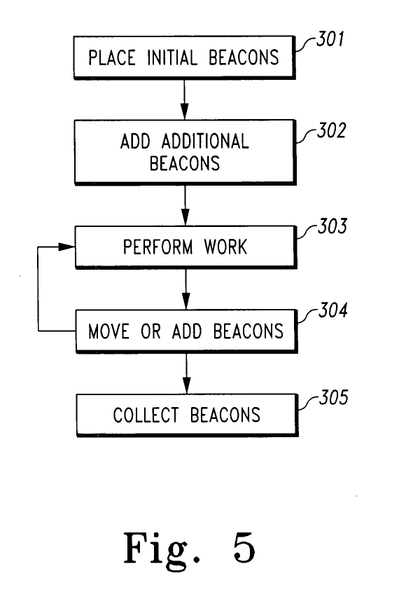

FIG. 5 is an overview of a process or method 300 used to guide a mobile object 110 and determine the location thereof. At step 301, initial beacons must be placed to establish a reference coordinate system. Once this reference is established the mobile object can navigate and find a location to place additional beacons in step 302. Once sufficient beacons have been placed to enable precision movement, the mobile object can perform work 303 within the coverage area. Beacons can be added or moved 304 in order to provide localization and guidance information throughout the entire area of the task. This process of moving beacons and performing work continues until the entire task is completed, at which point all of the deployed beacons can be collected.

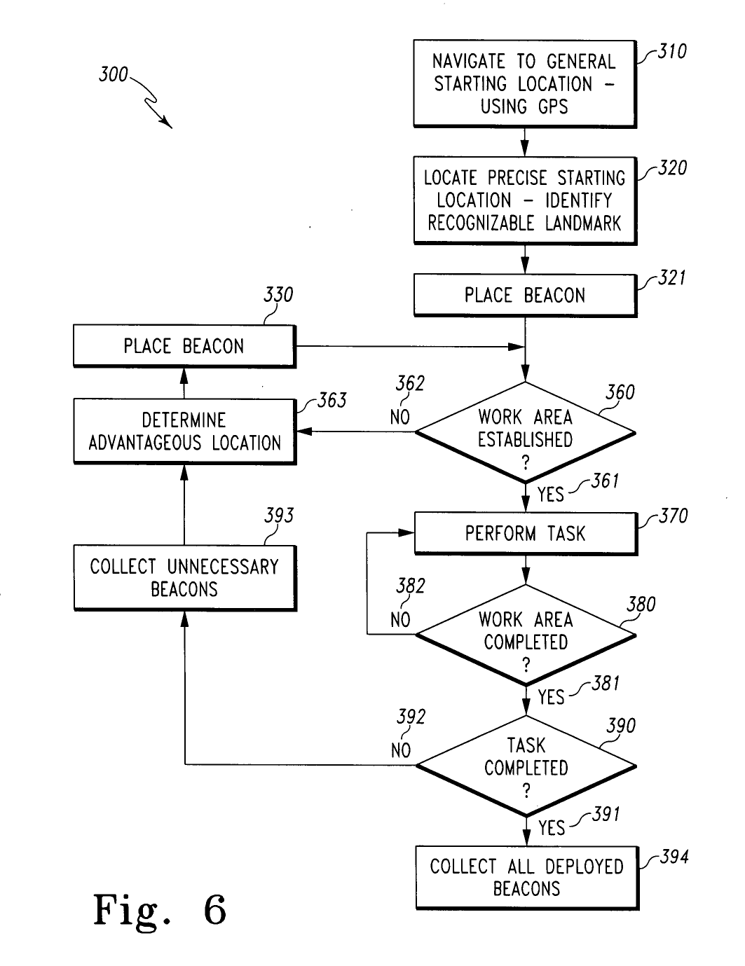

The method 300 used for dynamically deploying beacons in order to localize and guide a mobile object is explained within reference to FIG. 6. At step 310 the mobile object 110 must navigate to the general work area. Because precision localization is not required during this stage, a cheap and commercially available solution, such as GPS, can be used. Alternatively, this step can be avoided altogether if the mobile object is already in the general area.

After reaching the general area, the beacon based localization system needs to be deployed for precision movement. As discussed earlier, two beacons are required for localization. Preferably, an absolute reference will be established by placing the first two beacons, 120A and 120B, at a known location. The known location could be a recognizable permanent landmark identifiable using vision or other methods 320. The beacons are then placed 321. Alternatively, the beacons can be placed at some distance from each other by identifying two starting locations. Separating the beacons has the advantage of providing a larger initial coverage area.

The steps of locating the general area and the precise starting location can be avoided by placing permanent reference beacons. This still allows the mobile object to dynamically place additional beacons, overcoming coverage problems, and allowing for precise establishment of the coordinate system. Alternatively, if an absolute reference is not required, the mobile object 110 could place the initial beacons arbitrarily, establishing an unreferenced coordinate system.

At step 360 the mobile object must determine whether sufficient beacons have been placed to cover the work area. The work area does not have to be large enough to complete the task in one step, as work areas can be moved and redefined throughout the process. It must only be large enough for the mobile object to perform some portion of its assigned task. If the work area is not fully and unambiguously established 362, then the mobile object 110 must determine an advantageous location 363 for an additional beacon. The advantageous location 363 is determined in furtherance of the goal of providing an unambiguous work area. This may simply mean that an additional beacon is required near the edge of the existing area to increase the total coverage area.

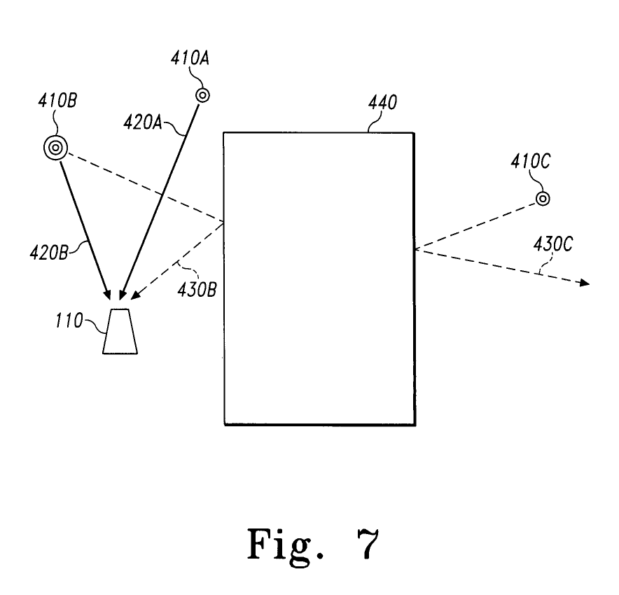

Alternatively, the advantageous location 363 could be determined in order to minimize multipath errors or occlusions caused by various features. Features are variations in the environment including, but not limited to, structures, obstacles and objects. The advantageous location determinations 363 are further explained with reference to FIG. 7. It is foreseeable that within the localization area permanent objects may interfere with localization. For example, the building 440 (a feature) occludes the signal 430C from the beacon 410C on its way to the mobile object 110. This problem can be overcome by placing an advantageously located beacon 410A within clear view of the mobile object 110. The signal 420A is then free to travel directly to the mobile object 110.

In a similar issue of problematic beacon location, the beacon 410B has multipath reflection problems caused by a feature. The true signal 420B reaches the mobile object 110 normally, but the reflected signal 430B arrives both at a later time and incorrect angle. This reflected signal 430B gives the mobile object 110 a false image of a beacon. Once again beacon 410A is advantageously placed to minimize the issue. By placing the beacon 410A at the end of the building the reflection angle is increased based upon the change of the angle of incidence. This increased reflection angle will cause reflected signals to travel harmlessly past the mobile object.

Once again referring to FIG. 6, after an advantageous location 363 has been determined, the mobile object 110 places the beacon 330. If it is determined that the work area is still not established 362 the process repeats. However, if the work area is established 361 the mobile object continues to step 370 and begins performing the assigned task. At step 380 a continuous process of checking for completion of the work area begins. If the work area is not completed 382, performance of the task 370 resumes. Upon completion of the work area 381, the mobile object must determine if the entire task is completed 390. If the mobile object has completed the work area, but not the entire task 392, then it must relocate to a new work area and begin the process over. First the mobile object should collect any unnecessary beacons 393 from the work area. The mobile object then begins determining advantageous locations 363 and placing beacons 330 until the new work area is established 360. At this point the work area completion 380 cycle starts again until the entire task is completed 391.

After completing the task, the mobile object can collect all deployed beacons 394. After collecting all of the beacons the mobile object 110 can recharge them so that they are ready for a future deployment. It is important to point out that anywhere in the process when beacons are on board, mobile object beacon recharging can take place.

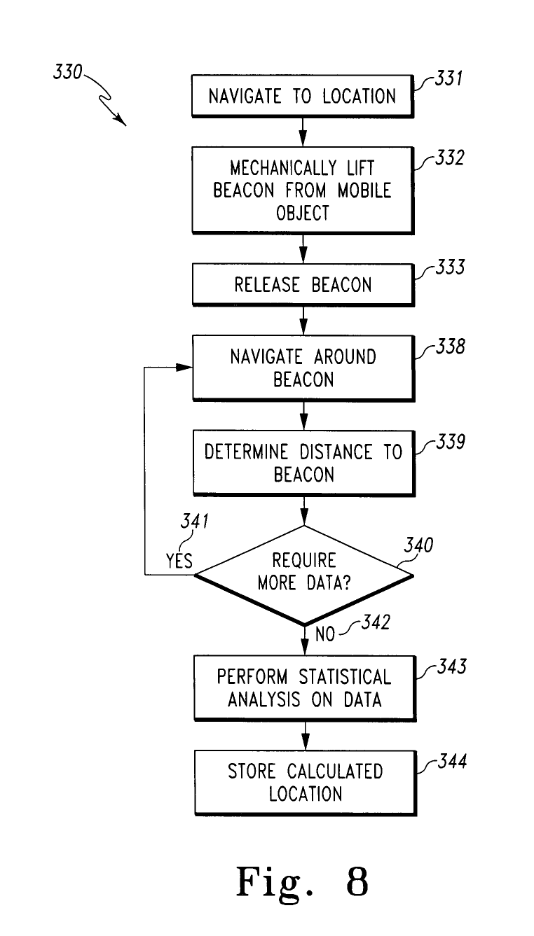

FIG. 8 is a flow diagram for further explaining the process of placing a beacon 330. After determining an advantageous location, the mobile object must navigate the location 331. The location determination unit can determine the present location and provide navigation instructions for reaching the desired location. Once at the location, the beacon is mechanically lifted from the mobile object 332 and released 333 onto the target surface.

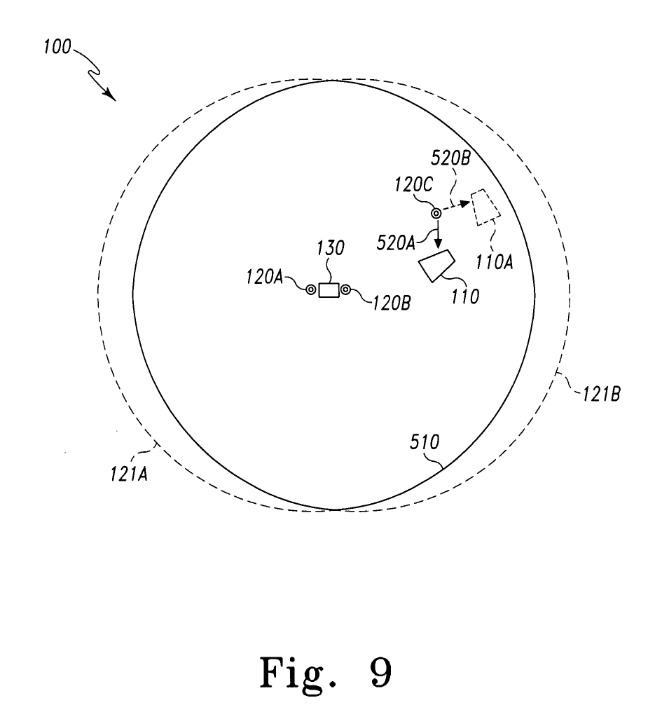

The methodology of location confirmation will be explained with reference to FIGS. 8 and 9. The mobile object 110 must navigate around the beacon 120C on a known path in step 338. While navigating the mobile object 110 periodically determines its own location based upon the other beacon emplacements 120A and 120B. The mobile object 110 can determine its location as long as it stays within the area 510. At step 339 the mobile object 110 determines the distance to the beacon 120C based upon the signal path 520A. A determination about whether or not more data is required 340 is made. This determination is based upon a predetermined programmed amount of measurements that the mobile object 110 should take. If more measurements remain 341, the process repeats as shown by the mobile object at updated position 110A measuring the distance to beacon 120C along the signal path 520B. Once sufficient data has been obtained 342 the mobile object can perform statistical analysis on the gathered data 343 to determine a calculated location of the beacon. This calculated location can then be stored 344 and used as the beacon location in future calculations.

Alternatively, the mobile object could perform the statistical analysis 343 before step 340. This would allow the mobile object to make a determination as to whether more data is required based upon the error associated with the statistical analysis.

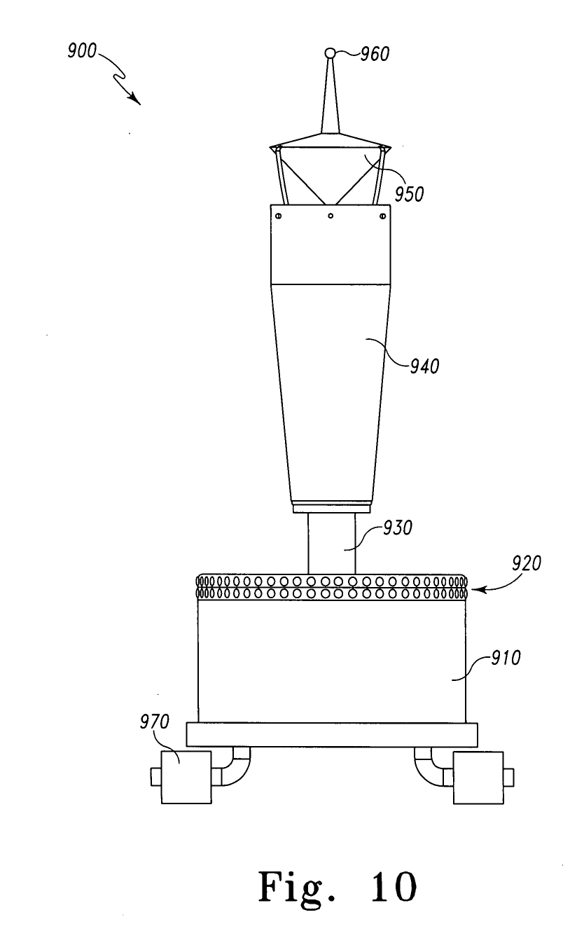

FIG. 10 is a diagram of an alternate embodiment of a mobile beacon 900. The mobile beacon 900 has an omni directional ultrasonic reflector 940, and an array of infrared transmitters 920. The channeling funnel 940 is attached to the base 910 by a non flexible support 930. In terms of localization the mobile beacon 900 functions as any other beacon would by receiving an ultrasonic signal and responding with an infrared signal. The entire mobile beacon 900 can be moved by powered wheels 970. The beacon places itself according to instructions received via the radio antenna 960. Preferably, the instructions would come from a mobile object 110 with a similar radio antenna. The mobile object can direct the mobile beacon 900 to position itself at an advantageous location for localization. In a slightly different embodiment, the mobile beacon 900 could contain within its base 910 the computation equipment necessary for determining its own location based upon the location of other beacons. This would allow for a swarm mentality wherein each beacon moves automatically, anticipating the need for a localization area and moves itself to an advantageous location.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected.

What is claimed is:

1. A localization system comprising:
a mobile object;
a plurality of dynamically positionable beacons stored on the mobile object;
a beacon deployment unit associated with the mobile object for deploying the dynamically positionable beacons; and
a location determination unit associated with the mobile object for determining location of the mobile object.

2. The localization system of claim 1, wherein the plurality of dynamically positionable beacons are rechargeable, and further comprising a beacon recharging unit associated with the mobile object for recharging the plurality of rechargeable beacons.

3. The localization system of claim 1, wherein the beacon deployment unit is further operable to retrieve a deployed beacon.

4. The localization system of claim 1, further comprising a deployed fixed beacon.

5. The localization system of claim 1, wherein the mobile object comprises a unit for performing work.

6. The localization system of claim 1, further comprising a communication unit associated with the mobile object for communicating with any one of the plurality of beacons.

7. The localization system of claim 1, wherein each of the plurality of beacons includes:
a location determination unit for determining location of the beacon; and
a communications unit for communicating with the mobile object and other beacons.

8. The localization system of claim 1, wherein the beacon deployment unit includes a communications unit for communicating beacon location instructions.

9. The localization system of claim 8, wherein the mobile object includes:
a communications unit for communicating with the beacon deployment unit;
a beacon placement unit for placing a beacon onto a target surface; and
a beacon collection unit for retrieving the beacon from the target surface.

10. The localization system of claim 1, wherein each beacon includes:
a location determination unit for determining location of the beacon;
a communications unit for communicating with the beacon deployment unit; and
a drive unit for self movement based upon beacon location instructions.

11. A method for dynamically moving beacons of a localization system, the method comprising:
communicating beacon location instructions to a mobile object;
causing the mobile object to move itself into position for beacon deployment;
mechanically lifting a beacon stored on the mobile object from the mobile object;
releasing the lifted beacon onto a target surface; and
storing location of the released beacon.

12. A method for dynamically moving beacons of a localization system, the method comprising:
directing deployment of a beacon from a mobile object of the localization system at a starting location; and
storing a location of the deployed beacon.

13. The method of claim 12, wherein the starting location is a predetermined location.

14. The method of claim 13, wherein the predetermined location comprises a location identified by recognizable landmarks.

15. The method of claim 13, wherein the predetermined location comprises a location identified by use of GPS.

16. The method of claim 12, wherein directing deployment of a beacon comprises:
communicating beacon location instructions to the mobile object;
causing the mobile object to move itself into position for beacon deployment;
mechanically lifting the beacon from the mobile object; and
releasing the beacon onto a target surface.

17. The method of claim 12, wherein directing deployment of a beacon comprises:
communicating beacon location instructions to the beacon; and
causing the beacon to move itself into position.

18. The method of claim 12, further comprising:
determining an advantageous location for an additional beacon;
directing deployment of the additional beacon; and
storing location of the additional beacon.

19. The method of claim 18, wherein the advantageous location is determined based upon existing beacon locations in order to expand available coverage area.

20. The method of claim 18, wherein the advantageous location is determined based upon existing features in the area in order to minimize multipath reflections.

21. The method of claim 18, wherein the advantageous location is determined based upon existing features in the area in order to minimize occlusions.

22. The method of claim 18, wherein directing deployment of an additional beacon comprises:
communicating additional beacon location instructions to the additional beacon; and
causing the additional beacon to move itself into position.

23. The method of claim 22, wherein directing deployment of an additional beacon further comprises:
communicating additional beacon location instructions to the mobile object;
causing the mobile object to move itself into position for beacon deployment;
mechanically lifting the additional beacon from the mobile object;
releasing the additional beacon onto a target surface; and
storing location of the additional beacon after deployment.

24. The method of claim 23, wherein storing location of the additional beacon after deployment comprises:
determining and storing location of the mobile object over multiple iterations;
performing statistical analysis on the multiple iterations to determine a calculated location of the mobile object;
deriving location of the additional beacon from the calculated location of the mobile object; and
storing the derived location of the additional beacon.

25. The method of claim 23, wherein storing location of the additional beacon after deployment comprises:
causing the mobile object to navigate around the additional beacon on a known path;
determining and storing location of the mobile object and distance between the mobile object and the additional beacon at multiple locations within the known path;
performing statistical analysis on the locations and distances to determine a calculated location of the additional beacon; and
storing the calculated location of the additional beacon.

26. The method of claim 18, wherein one or more of the deployed beacons can be retrieved for future deployment by:
selecting which of the deployed beacons to retrieve;
causing the mobile object to navigate to the selected beacon;
mechanically lifting the selected beacon from its current position; and
releasing the selected beacon onto the mobile object.

27. The method of claim 26, further comprising recharging the beacon.
